(19) United States
(12) Patent Application Publication
(10) Pub. No.: US 2010/0180212 A1
(43) Pub. Date: Jul. 15, 2010

(54) METHOD AND APPARATUS FOR SHARING CALENDAR INFORMATION

(75) Inventors: Marc Gingras, Verdun (CA); Jennifer Lanne Bell, Montreal (CA); Fang Yang, Waterloo (CA); Alexander Kress, Richmond Hill (CA)

Correspondence Address: WOLF GREENFIELD & SACKS, P.C., 600 ATLANTIC AVENUE, BOSTON, MA, 02210-2206, US

(73) Assignee: Tungle Corporation, Montreal QC (CA)

(21) Appl. No.: 12/532,342

(22) PCT Filed: Sep. 21, 2007
(86) PCT No.: PCT/CA2007/001707

§ 371 Date: Mar. 11, 2010

Related U.S. Application Data
(60) Provisional application No. 60/895,762, filed on Mar. 20, 2007.
(60) Provisional application No. 60/895,766, filed on Mar. 20, 2007.

(51) Int. Cl. G06F 3/01

(52) U.S. Cl. 715/751

(57) ABSTRACT

A system for sharing calendar information. The system may comprise a graphical user interface implemented on a computer for sharing calendar information with a third party residing at a remote site, the graphical user interface comprises a selection tool operable by a user on the computer for selecting a time range from a calendar program executed by the computer, the calendar program maintaining a schedule of events for the user over a certain time period. The time range is a subset of the certain time period, the time range being characterized by one or more free time slots within the time range, whereby the user is available for taking part in an activity. The time range is further characterized by one or more busy time slots within the time range, whereby the user is unavailable to take part in an activity. The selection tool causes the time range to be exposed to the third party residing at a remote site such that the third party can determine the free and busy timeslots.

### CROSS REFERENCE TO RELATED APPLICATIONS

This application claims priority from U.S. provisional application 60/895,766 filed on Mar. 20, 2007 and from U.S. provisional application 60/895,762 filed on Mar. 20, 2007, both of which are hereby incorporated by reference in their entirety.

### FIELD OF THE INVENTION

The present invention relates to the field of data exchanging and in particular to technology allowing remote users to share calendar information.

### BACKGROUND OF THE INVENTION

As computing technologies continue to improve an increasing number of people are using electronic solutions to keep track of their schedules. Prior to the computerizing of calendars, physical implements such as paper agendas were used to keep track of events. Today however, computers have taken over traditional solutions and have added new functionality to them. Calendar and other personal information programs can now keep track of planned events for a user and provide him with reminders in multiple form, of upcoming events. In addition, many programs can now keep track of a user's personal and business contacts, rendering old solutions like the rolodex obsolete.

In today's interconnected environment, a user may resort to several different types of implements to satisfy his computing needs. Whereas in the past, only large non-portable computers had the power to execute electronic instructions, today computers take all sorts of forms, including small portable ones and are found everywhere. Cellular phones, laptops, desktops and personal digital assistants (PDA's) are all example of computers today having the power to run a program with a graphical user interface and some of them run calendar applications.

Calendar programs in existence today are plagued with many deficiencies, especially in the realm of calendar information sharing, that have prevented them from obtaining universal adoption. One of the main such deficiencies is the incompatibility between different programs that makes it impossible for users of different calendar program to seamlessly integrate and share calendar data.

Another deficiency is that calendar programs fail to provide a way of sharing calendars that is secure and safe and wherein calendar data is can be shared without being uploaded onto a server.

Yet another deficiency is that they fail to provide a way to efficiently control access to a user's calendar data by another user.

In the context of the above, it can be appreciated that there is a need in the industry for a personal information manager that does not suffer these deficiency.

### SUMMARY OF THE INVENTION

In accordance with a first broad aspect, the present invention provides a graphical user interface implemented on a computer for sharing calendar information with a third party residing at a remote site, the graphical user interface comprises a selection tool operable by a user on the computer for selecting a time range from a calendar program executed by the computer, the calendar program maintaining a schedule of events for the user over a certain time period. The time range is a subset of the certain time period, the time range being characterized by one or more free time slots within the time range, whereby the user is available for taking part in an activity. The time range is further characterized by one or more busy time slots within the time range, whereby the user is unavailable to take part in an activity. The selection tool causes the time range to be exposed to the third party residing at a remote site such that the third party can determine the free and busy timeslots.

In accordance with a second broad aspect, the present invention provides a computer readable storage medium storing instructions for execution by a first computer to implement a calendar sharing program, the calendar sharing program includes a selection module responsive to inputs by a user on the first computer for selecting a time range from calendar data, the calendar data containing a schedule of events for the user over a certain time period. The time range is a subset of the calendar data, the time range being characterized by one or more free time slots within the time range, whereby the user is available for taking part in an activity. The time range has one or more busy time slots within the time range, whereby the user is unavailable to take part in an activity. The calendar sharing program further includes communications module to generate a transmission conveying the time range for reception by a remote computer allowing a user at the remote computer to visualize the time range.

In accordance with a third aspect, the present invention provides a A computer readable storage medium storing instructions for execution by a first computer to implement a calendar sharing program, the calendar sharing program including selection module responsive to inputs by a user on the first computer for selecting a time range from calendar data, the calendar data containing a schedule of events for the user over a certain time period, wherein the time range is a subset of the calendar data, the time range being characterized by: one or more free time slots within the time range, whereby the user is available for taking part in an activity; and one or more busy time slots within the time range, whereby the user is unavailable to take part in an activity; and a communications module to generate a transmission conveying the time range for reception by a web server allowing a user at a remote computer to visualize the time range from the web server by using a web browser.

In accordance with a fourth broad aspect, the present invention provides a graphical user interface implemented on a computer for viewing information from a calendar of a third party residing at a remote site, said graphical user interface comprising: a visualization tool for graphically displaying a time range extracted from a calendar program associated with the remote site, the calendar program maintaining a schedule of events for the third party over a certain time period, wherein the time range is a subset of the certain time period, the time range being characterized by: one or more free time slots within the time range, whereby the third party is available for taking part in an activity; and one or more busy time slots within the time range, whereby the third party is unavailable to take part in an activity; and a selection tool operable by a user on the computer for: designating within the time range one or more time slots during which the user is free to take part to an activity; and causing the updating of the calendar information at the remote site and graphically displaying to the third party the one or more time slots during which the user is free to take part to an activity.

In accordance with a fifth broad aspect, the present invention provides a computer readable storage medium storing instructions for execution by a computer to implement a calendar sharing program, the calendar sharing program including: a scheduling module for receiving messages from at least one remote computer, the messages including scheduling information in connection with a meeting between at least two individuals wherein at least one of the individuals reside at a remote computer; a conference scheduler for communicating with the scheduling module to generate a message to convey the scheduling information at least in part to a remote server and request the setting up of a conference resource for the meeting; and the conference resource allowing voice communications to be exchanged between at least two participants that are at remote locations from one another.

In accordance with a sixth broad aspect, the present invention provides a calendar sharing system for permitting a first user to view calendar data concerning a second user wherein the second user is located at a remote location from said first user, said system comprising: a first end user program for use by the first user at a first computer, said first computer storing calendar information concerning said first user; a second end user program for use by the second user at a second computer, said second computer storing calendar information concerning said second user; and a centralized server located remotely from said first computer and said second computer, said centralized server operable for allowing a third user at a third computer located remotely from said first computer and said second computer to view at least a portion of the calendar information stored at said second computer; wherein said first end user program is operable for receiving from said second end user program a portion of the calendar information stored at said second computer without intervention of the centralized server.

In accordance with a seventh broad aspect, the present invention provides a computer readable storage medium storing instructions for execution by a computer to implement a calendar sharing program, the calendar sharing program including: a scheduling module for receiving messages from at least one remote computer, the messages including scheduling information in connection with a meeting between at least two individuals wherein at least one of the individuals reside at a remote computer; and a conference scheduler for communicating with the scheduling module to generate a message to convey the scheduling information at least in part to a remote server and request a reservation of a service.

These and other aspects and features of the present invention will now become apparent to those of ordinary skill in the art upon review of the following description of specific embodiments of the invention and the accompanying drawings.

### BRIEF DESCRIPTION OF THE DRAWINGS

A detailed description of examples of implementation of the present invention is provided hereinbelow with reference to the following drawings, in which:

FIG. 1 is a block diagram showing a personal information manager in accordance with a non-limiting example of implementation of the invention;

FIG. 2 is a block diagram of an end user program for implementing the personal information manager depicted in FIG. 1;

FIG. 3 shows a block diagram of a peer-to-peer network in accordance with yet another non-limiting embodiment;

FIG. 4 is a flowchart showing the steps involved in an exemplary use of the personal information manager;

FIG. 5 is a Graphical User Interface (GUI) showing an initialization window of the personal information manager;

FIG. 6 shows the GUI of FIG. 5 depicting a login window;

FIG. 7 shows the GUI of FIG. 5 depicting a buddy window;

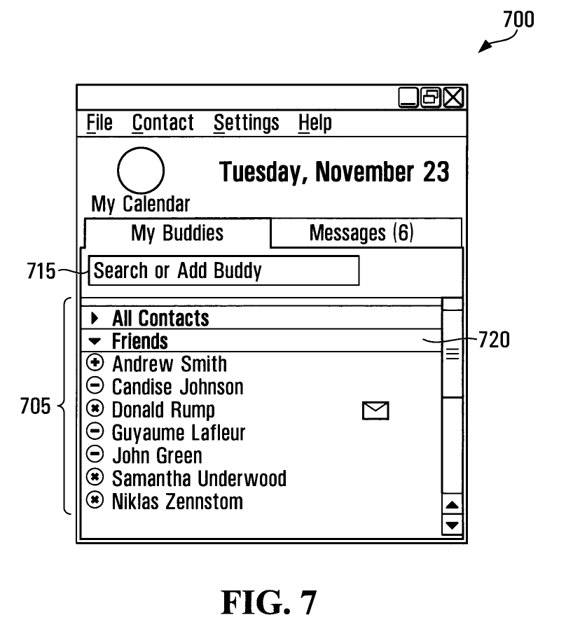

FIG. 8 shows the GUI of FIG. 5 depicting a message window;

FIG. 9 shows the GUI of FIG. 5 depicting a calendar window;

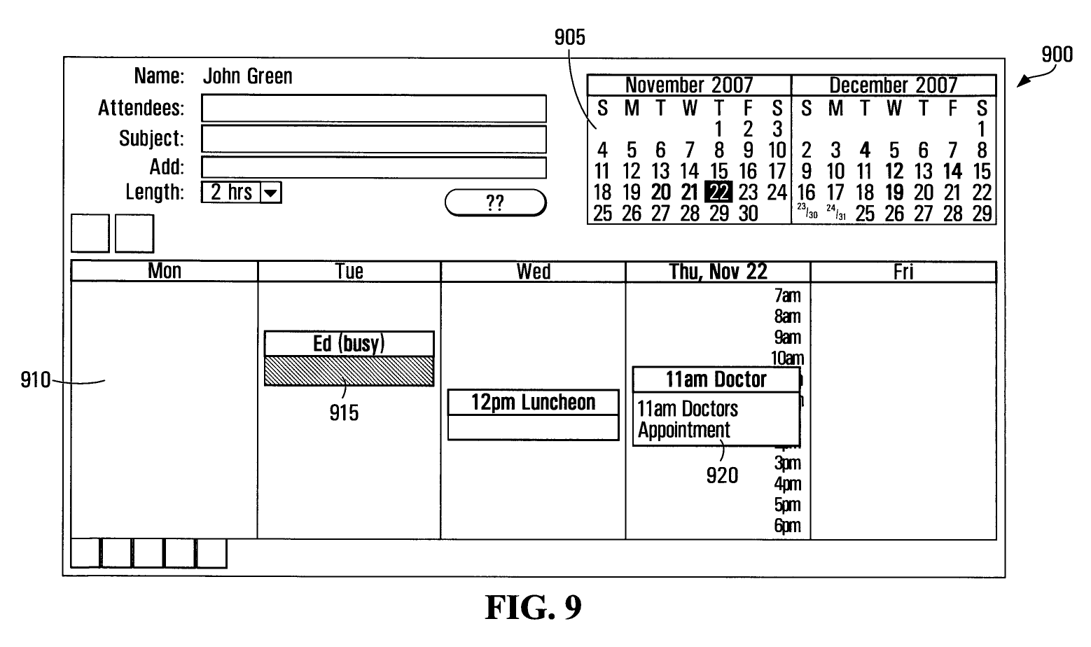

FIG. 10 shows the GUI of FIG. 5 depicting a share request window;

FIG. 11 shows the GUI of FIG. 5 depicting a suggest window; and

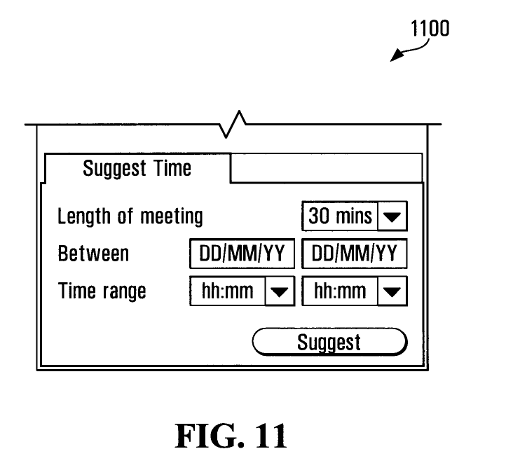

FIG. 12 shows the GUI of FIG. 5 depicting a time space representation.

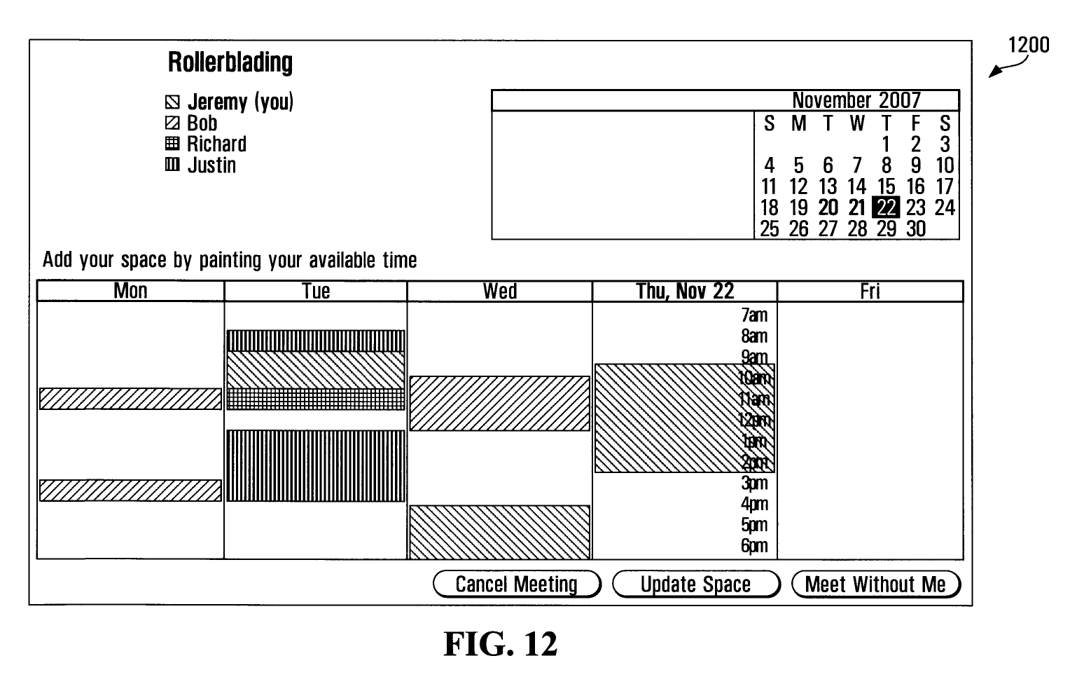

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

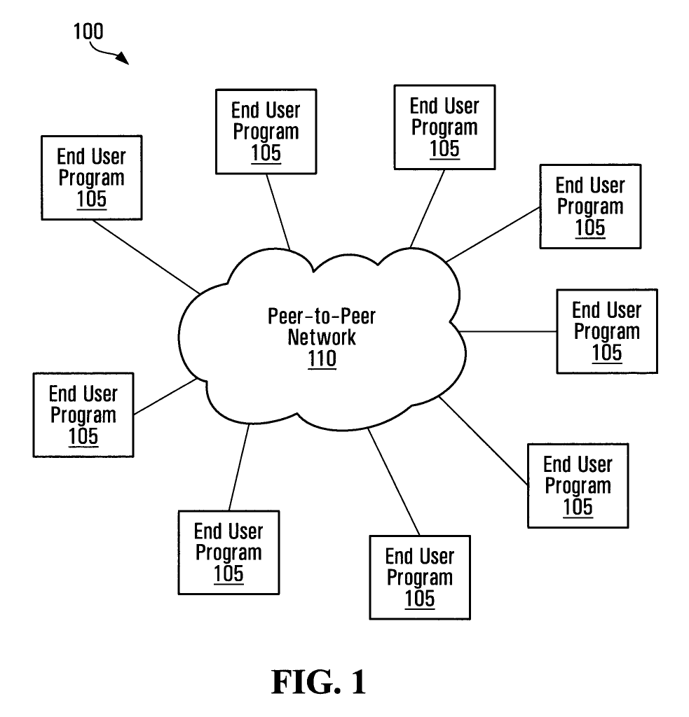

FIG. 1 illustrates a personal information manager 100 in accordance with a non-limiting embodiment. In a non-limiting embodiment personal information manager 100 includes a plurality of end user programs 105, connected through a network such as a per-to-peer network.

The structure of the personal information manager 100 will now be described in accordance with non-limiting examples of embodiments.

Structure of the Personal Information Manager

The personal information manager 100 includes a plurality of modules that interact to provide end users with personal information management functionality such as the ability to share calendar information and to book meetings with buddies. In a non-limiting embodiment, the personal information manager 100 includes a plurality of end user programs 105 and at least one central control program running on a central server.

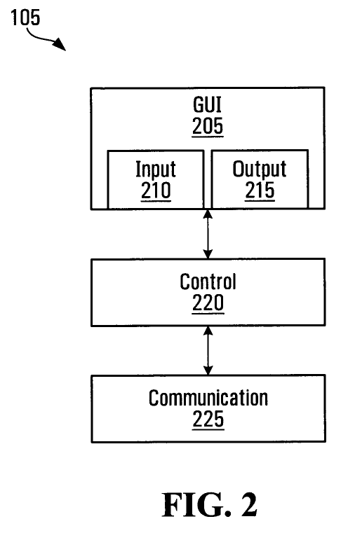

In a non-limiting embodiment illustrated in FIG. 2, end user program 105 takes the form of a calendar program or a calendar sharing program executing on a personal computer. As illustrated, end user program 105 includes a graphical user interface 205 for interfacing with a user, a communication module 225 for interfacing with other modules of personal information manager 100 and a control module 220 for controlling overall function of personal information manager 100. The graphical user interface 205 includes a series of tools for interfacing with a user and includes an input interface 210 and an output interface 215. The input interface 210 is in communication with input devices on the end user's computer for receiving input from the end user and providing it to the end user program 105. The output interface 215 is in communication with the output devices end user's computer for providing an end user with information in the form of a graphical user interface 205. In a non-limiting example of embodiment, end user program 105 is a computer program that presents information on an end user's computer. The computer program can be any machine-readable instruction set and can take the form of a plugin, a java applet or an executable Windows® program. The end user's computer may be any suitable computing device capable of input/output and computation. In a non-limiting example the end user's computer is any one of the following devices: a personal computer, a PDA, a cellular telephone, a laptop computer or an electronic organizer.

The end user program 105 may be executed entirely on the end user's computer or may run on a separate computer, such as a web server. In the latter case, there may be one end user program 105 shared by a number of end users and the output interface 215 may take the form of a web page or a similar web browser-viewable file for display in an end user's web browser. In this example, the communication module 225 of the end user program 105 may be an internal communication module 225 regulating access to information by various end users or may be an integral part of the control module 220. Data storage of calendar information of the end user and of the end user's buddies may take place on the end user's computer or remotely, such as on the web browser.

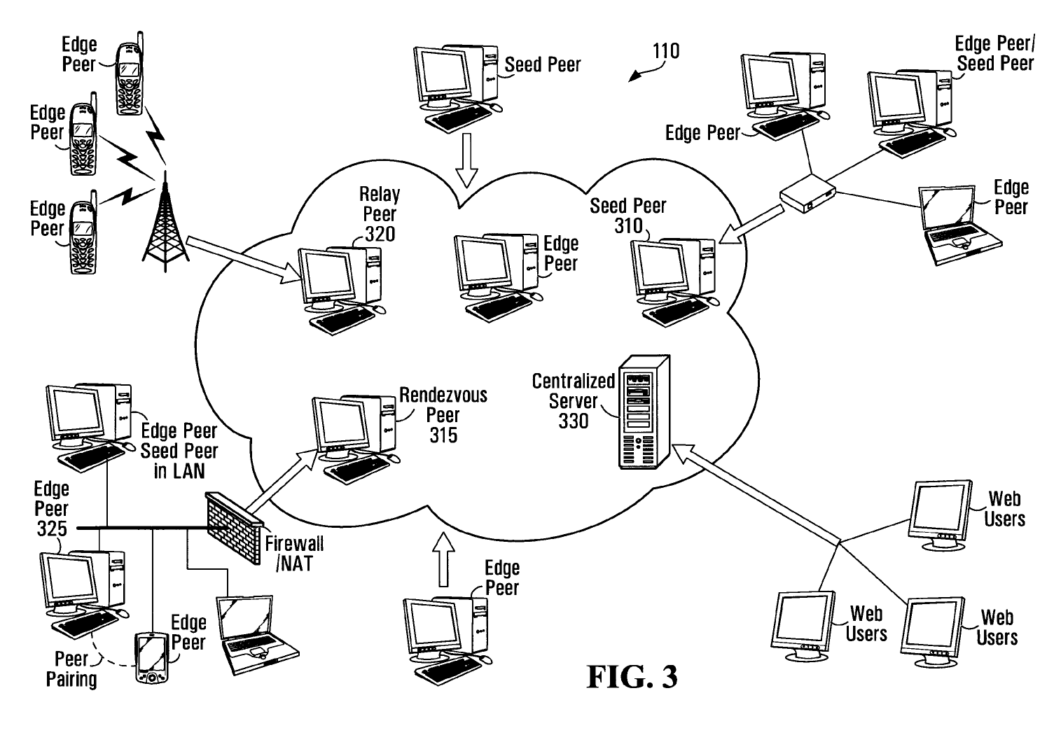

In a non-limiting embodiment, the end user program 105 and the end user's calendar information reside on the end user's computer. In this exemplary embodiment, the end user program 105 is used to communicate calendar information with buddies using a peer-to-peer networking protocol. FIG. 3 shows an exemplary embodiment of a peer-to-peer network 110. The peer-to-peer networking protocol can be centralized, decentralized, structured or unstructured. In a non-limiting example, the peer-to-peer network 110 includes a plurality of peer-to-peer nodes, said nodes being either super nodes or edge nodes 325.

Super nodes act as “servers” to a subset of end user clients, such as end user programs 105. There are three types of super nodes. Seed nodes 310 are known by certain clients, and are contacted by these clients upon start up to obtain the locations of currently running rendezvous and relay nodes 315, 320.

Rendezvous nodes 315 act as global databases on all resources on the network, allowing nodes to locate other nodes or super node services.

Relay nodes 320 act as a gateway for nodes that are behind firewalls or network address translation systems to the peer-to-peer network 110.

In addition to the super nodes, the peer-to-peer network 110 also includes edge nodes 325 which reside on the logical periphery of the network. Edge nodes 325 are clients that that connect to the network without being responsible for any server duties. Edge nodes 325 may have a certain number of trusted nodes with which they share calendar information.

In a non-limiting embodiment, edge nodes 325 can be promoted to super nodes and super nodes may be demoted to edge nodes 325 or transformed into other types of super nodes in accordance with a promotion algorithm. Accordingly, both super nodes and edge nodes 325 may be end user programs 105 providing the functionality described above to an end user.

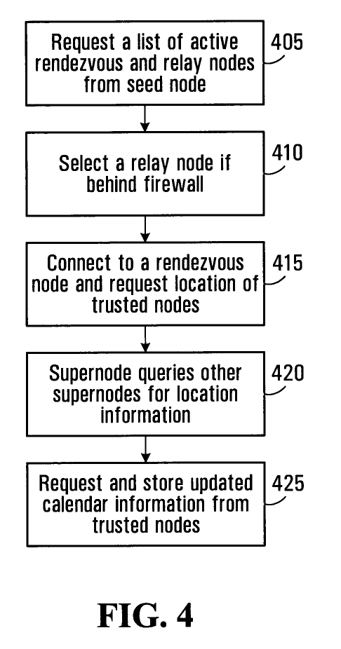

The steps involved in communication over the peer-to-peer network 110 will now be described in accordance with a non-limiting embodiment illustrated in FIG. 4. In step 405, an edge node 325 wanting to connect to the network first sends a message to a seed node 310 to request a list of active rendezvous nodes 315 and relay nodes 320 on the network. The seed node 310 may also inform the edge node 325 whether it is behind a firewall.

In step 410, if the edge node 325 is behind a firewall, it will select one of the relay nodes 320 to connect to a rendezvous node 315 and other network peers (step 415). Otherwise it connects directly in step 415 to a rendezvous node 315 and other network peers. The rendezvous node 315 itself, once contacted, keeps information on the location of the edge nodes 325, which is shared with other nodes authorized to have that information.

After having established contact with the super node, the edge node 325 queries the super node for information on the location of other nodes. Because location information of edge nodes 325 may be located on different super nodes, the super node in step 420 queries other super nodes on behalf of the requesting edge node 325.

Once every node to be peered to the edge node 325 has been located, calendar information is shared between the nodes directly, without going through a rendezvous node 315. Advantageously, the two peers involved in a communication are the only two that store the information exchanged; no information needs reside on a central server. Thus peer-to-peer communication provides a secure, reliable base for personal information manager 100.

Once an edge node 325 has completed the process of connecting to the peer-to-peer network 110 it queries in step 425 each trusted edge node 325 for updated calendar information relating to the user at the trusted node. Trusted edge nodes may be remote nodes that have authorization to receive calendar information belonging to the local user or may be nodes from which the local user is authorized to receive calendar information. In a non-limiting embodiment the end user program 105 may keep a list of unique identifiers of nodes that are authorized to receive calendar information belonging to the end user or to send to the end user calendar information corresponding to a remote user. Optionally, end user program 105 may also send, without being requested, updated calendar information relating to the local user to trusted nodes. Each nodes store the calendar information of the node's user and the calendar information obtained from other nodes locally.

When the calendar information of the user of a node is modified, the node sends updated calendar information to other trusted nodes such that they may have the most current calendar information. It is to be appreciated that updated calendar information may be new calendar information or, alternatively, information representative of the modifications brought to the calendar information.

Thus when a node is in communication with another node, the calendar information shared between nodes is always up-to-date. However, when a node is not in communication with a peer, such as when the peer is offline, it is possible that the calendar information relating to that peer is not up-to-date. Furthermore, if the calendar information of the peer held at the node is not up-to-date, it is possible that another peer somewhere has more up-to-date information on the offline peer having, for example, been in communication with the peer more recently. In such a case, a node may share with another node calendar information relating to yet another node, if there is proper permissions for such a transaction.

The personal information manager 100 may include a central server either in combination with a peer-to-peer network 110 or instead of a peer-to-peer network 110. In the latter case, end users connect to the centralized server, such as centralized server 330 illustrated in FIG. 3 to retrieve calendar information stored thereon. The centralized server 330 is responsible for managing permissions to access information and for properly updating calendar information provided to users.

In another non-limiting embodiment a centralized server 330 may be used in conjunction with a peer-to-peer network 110 to facilitate communication with buddies that are not users of the personal information manager 100. In such a case, the centralized server 330 may be used to host calendar information for and receive calendar information from non-users of the personal information manager 100. For example, calendar information of users of the personal information manager 100 may be compiled into a web page to be temporarily hosted on the centralized server 330. Non-users of the personal information manager 100 may then view the web page through a standard web browser and provide input corresponding to their calendar information via a webpage input interface 210. The input received at the centralized server 330 may then be used to update the web page and may also be sent to the users of personal information manager 100. Thus combining a centralized server 330 and a peer-to-peer network 110 may advantageously extend functionality of the personal information manager 100 to non-registered entities. As discussed above, a centralized server 330 may also hold the end user program 105 if it is to be executed remotely from the end user's computer.

It is to be appreciated that a web server as a centralized server 330 is intended only as an example of a possible means for providing information to non-users of the personal information manager 100, and that any other suitable means may be used to this end. Furthermore, one skilled in the art will readily appreciate that a centralized server 330 may also be used for other functionality, such as to supplement the peer-to-peer network 110 by providing a centralized location for information, by replacing the functionality of certain nodes or otherwise.

In a non-limiting embodiment, super nodes such as rendezvous nodes 315 and relay nodes 320 or even seed nodes 310 may be centralized servers 330 acting as nodes but not necessarily comprising an end user program 105 having the functionality described herein. Advantageously, a peer-to-peer network 110 having certain supernodes provided by centralized servers 330 may be able to guarantee certain parameters affecting the quality of the peer-to-peer network.

In a non-limiting embodiment, the peer-to-peer network 110 uses a combination of peer-to-peer architecture and client-server architecture to provide the functionality described herein. Any suitable way of meshing the two types of architecture may be used and in a non-limiting example, at least one centralized server 330 is a dual centralized server that emulates one or many peers such that communication between a peer and the centralized server 330 takes place using a peer-to-peer protocol. Advantageously, the centralized server 330 may thus function as both a server and a peer and a server providing dual functionality to the peer-to-peer network. In a non-limiting example, a centralized server 330 may be accessed as a server by parties outside the peer-to-peer network 110 using a regular client-server protocol and be accessed by users of the personal information manager 100 that are using the peer-to-peer network 100 via a peer-to-peer protocol. Optionally, the centralized server 330 may be able to emulate multiple instances of peers, each instance being in communication with one peer in the peer-to-peer network. Thus a user of an end user program 105 may “see” the centralized server 330 as one (or potentially many) peers.

Calendar Sharing

In a non-limiting embodiment a user may use end user program 105 to share a portion of his calendar with a remote peer, who can be, for example a third party residing at a remote site. In this embodiment, the graphical user interface 205 of end user program 105 includes a selection tool with which the user may select a time range to share with the peer. The time range may be any suitable subset of the calendar. In a non-limiting example, a time range can be a range of dates and/or times such as “Oct. 1, 1983 to Oct. 4, 1983” or “Monday, 3:00 p.m. to Friday 8:00 a.m.” The time range can be defined in any suitable manner and does not need to be continuous and in another non-limiting example, the time range can be a range of times applicable to a larger time range. For example, the time range could be “weekdays from 9:00 a.m. to 5:00 p.m.” or “during lunches” (during midday lunch breaks). The time range may be characterized by having a determined start date and end date, such as “Monday to Friday” or “Monday to Friday from 9:00 a.m. to 5:00 p.m.” In a non-limiting example, a time range can be defined as a succession of timeslots. For example, a user wanting to share his schedule of weekdays from 9:00 a.m. to 5:00 p.m. with the exclusion of lunches and Thursday afternoons, may select a range defined as the timeslots of 9:00 a.m. to 12:00 p.m. every day and the timeslots of 1:00 p.m. to 5:00 p.m. every day except Thursdays. In a non-limiting embodiment these timeslots may all be of equal duration. Timeslots may be of any suitable length of time including less than 12 hours, less than 6 hours and less than 3 hours.

In a non-limiting embodiment, the time range is also characterized by having information regarding the user's availability to take part in an activity taking place during the time represented, for example as free and busy timeslots. The selection tool may be graphical or other, such as textual. In a non-limiting example, the selection tool allows a user to enter in text fields, or select in drop-down menus the start date and end date, as well as any other suitable limitations, such as a daily time period (e.g. 9:00 am to 5:00 pm). In another non-limiting example, the selection tool may be graphical. In an exemplary embodiment of a graphical selection tool, the user may use a pointing device, such as a mouse, to indicate the time range on a visual representation of the user's calendar, such as by clicking and dragging a line or a box encompassing the start date and the end date.

The selection tool is coupled to the end user program 105's selection module which may be part of the graphical user interface module 205, the control module 220, both or be a separate entity. The selection module obtains the subset of the calendar data for a time range. In addition, the selection module may filter the data thereby obtained to remove certain information that are not to be shared with the peer. In a non-limiting example, the selection module may remove all information except the times at which the user is buys or free. In this embodiment, the time at which a user is free or busy may be represented as free or busy timeslots within the time range indicating a time that the user is free or busy.

In a non-limiting example, selection tool may allow the selection of a time range from amongst a group of pre-selected time ranges. A pre-selected time range may contain all the parameters of a time range or only a subset of the parameters of a time range, such that a user must input the remaining parameters. For example, a pre-selected time range to may be “all lunches”, or “today and tomorrow” or “this week”, or alternatively it may be “from today until—” the user having to input the end date. Advantageously selecting a time range from a group of pre-selected time ranges may be simpler and faster. This may be particularly useful when the user is on a computer that has a limited physical input interface, such as a cellular telephone that lacks a mouse. In a non-limiting example, a user having used the selection tool to select a time range or certain parameters thereof, may then save the time range, or certain parameters thereof in a group of pre-selected time ranges. A user may thus be spared having to repeatedly select the same time range if a certain time range is used more than once.

In a non-limiting example the selection tool is coupled to the communication module for causing the time range to be exposed to a third party residing at a remote site such that the third party can determine the free and busy timeslots. In response to user inputs, for example after the user has selected a time range, communication module 225 generates a transmission conveying a time range. In a non-limiting example, this transmission is destined to a peer for viewing the time range or some of the calendar data related to the time range, such as the user's availability, on his computer. In another non-limiting embodiment, communication module 225 generates a transmission conveying a time range to a centralized server such as a web server for allowing access to the time range by remote users using a web browser. In this embodiment, the end user program may via the communication module, generate a data message, destined for a peer, inviting the peer to access the time range on the centralized server. For example, if the time range is hosted on a web server, the end user program may cause an e-mail to be sent to a peer, the e-mail containing the link to a web page containing the time range.

Optionally, the e-mail may also contain authorization information for allowing the peer access to the time range through an authorization-verification layer. Authorization information may be any suitable information including a simple username/password combination.

In a non-limiting example, communication module initiates transmissions conveying time ranges in response to a user identifying a time range using the selection tool. In another non-limiting example, communication module initiates such transmissions whenever a change is made to the calendar data related to the time range. For example, if the user books a meeting during a time period contained within the time range and therefore becomes “unavailable” during this time, the communication module may send a message representative of a time range update to the recipient of a previous transmission that was representative of a time range.

It is to be understood that although the time range has been described here as including the information regarding the availability of the user to take part in an activity, the time range can include information regarding the availability of any number of individuals to take part in the activity including or excluding the user of the end user program 105. For example if an end user has the permission to view his teammates' calendar information, he may be able to share calendar data, for example by causing a transmission conveying the time range to a third party, where the time range includes information regarding the availability of the teammates to take part in an activity. It is not necessary for the end user's own availability information to be transmitted and in the example where an administrative assistant is using end user program 105 to view a professional's availability the end user program 105 can advantageously transmit only availability information of another user (in this case, thee professional) to a third party.

In addition to the selection tool, the end user program 105 may also feature an invitee selection tool with which a user may select invitees to an event planned, for example to an event envisioned during the time range selected using selection tool. Invitee selection tool may be graphical or textual and may allow the user to invite peers that are known, for example those stored in the “buddy list” described below or to invite new peers, using a unique label such as an e-mail address to identify them. In a non-limiting example, the invitee selection tool includes a combination of graphical and textual interfaces, the textual interface being a text box in which the user can enter an invitee's label while indicating other invitees with a pointing device, for example from a list adds the indicated invitee's label to the text box. Advantageously, communication module may generate transmissions regarding the time range (such as transmissions conveying the time range or data messages, described above) to invitees selected using the selection tool.

The reader is to appreciate that the above description of the personal information manager 100 is not intended to limit the invention but only to illustrate the invention according to a non-limiting embodiment.

It will therefore be readily appreciated that although the end user program 105 has been depicted mostly as a computer program running on an end user's computer any suitable means for interfacing with a user such as to provide him the capabilities described above may be used. Thus it may not be necessary to download or install an end user program 105 at all. Instead, it may simply be required to register by filling out an online form, for example if the end user program 105 takes the form of a web interface. Furthermore, even in the case that the end user program 105 does take the form of an instruction set executed on the end user's computer, the program may be obtained by any suitable means, including installed from a portable data storage medium and does not need to be downloaded.

A non-limiting embodiment of personal information manager 100 will now be described for the purpose of illustrating the present invention.

Using the Personal Information Manager

A potential user wanting to employ the personal information manager 100 begins by installing an end user program 105 onto his computer. In a non-limiting embodiment, the potential user downloads end user program 105 from the interne. The end user program 105 then takes the function of a peer-to-peer edge node. In a non-limiting example the end user program 105 may take the form of a super node if a promotion algorithm judges that the end user's equipment is suitable for such a role.

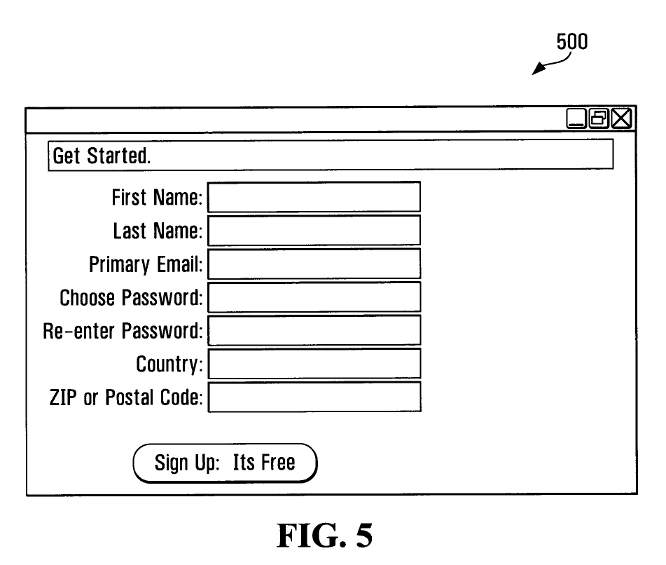

Upon installation of end user program 105, the potential user is guided through an initialization process during which the potential user registers to personal information management services and becomes an end user. A non-limiting example of an initialization process is illustrated in initialization window 200 in FIG. 5. During the initialization process, the potential user is requested personal information, chooses a password and obtains a unique identifier. The unique identifier will serve to identify a user from amongst the other users and in a non-limiting embodiment, will also be used to locate the user's node in the peer-to-peer network. The unique identifier may be any suitable datum for uniquely identifying an end user and in a non-limiting example, the unique identifier is the user's e-mail address. Of course any other suitable unique identifier may be used, including a simple ID number, which identifier may be provided by the user or by the personal information manager 100. One skilled in the art will appreciate that initialization may take place at anytime prior to use of the personal information manager 100 and needs occur after installation but may occur before.

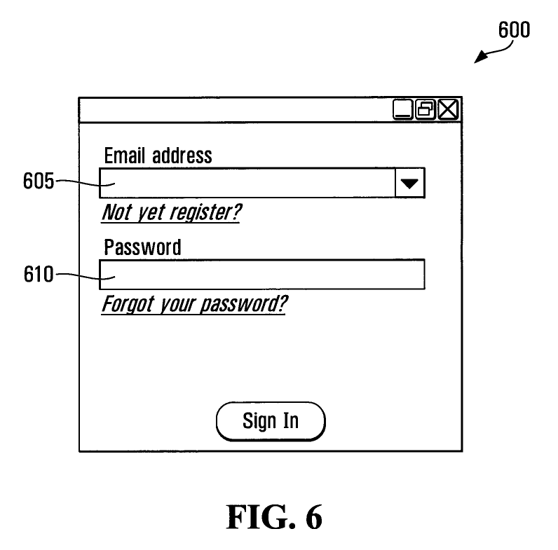

As illustrated in FIG. 6, when a registered end user opens the end user program 105, he is prompted for his unique identifier and password in a log in window 600. Upon entering this information, the end user program 105 logs him on. One skilled in the art will readily appreciate that any other means of validating the user's identity may be used. For example, the user may be identified by means of cookies stored on his computer.

Once logged on, an end user may be presented with several windows separately or in combination. These windows will be described here below.

Buddy Window

A buddy window 700 contains a buddy list 705 populated by buddies with whom the end user may share calendar information or with whom the end user may want to book a meeting. There are three categories of buddies:
1. Buddies that are users of the personal information manager 100 and that are sharing calendar information with the end user;
2. Buddies that are users of the personal information manager 100 but that are not sharing calendar information with the end user; and
3. Buddies that are not users of the personal information manager 100.

Buddies in category 1 and 2 represent other nodes in the peer-to-peer network. Buddies in category 1 correspond to nodes for which the end user is trusted. As will be appreciated, personal information manager 100 facilitates the organization of activities with all three types of buddies. It should be noted here that the three categories presented above represents an exemplary way of organizing buddies, but many other ways can be used, and additionally categories can be added without departing from the intended scope of the invention. In a non-limiting embodiment, the buddy list includes a visual indicator, such as an icon or a text color, to represent the category in which each buddy falls.

The buddy window 700 contains a series of tools for interfacing with the end user program. In a non-limiting embodiment, the buddy list is a list of labels representing buddies organized linearly and supplemented by an optional scroll bar such that a large number of buddies may be featured in the list. The buddy list may optionally also include additional information on each buddy in the form of visual clues such as icons, for indicating any of a number of information such as whether mail has been received from this buddy, whether the buddy is online or offline and whether there are any meetings planned with this buddy or if there is an imminent meeting with him.

In a non-limiting embodiment, right-clicking, or otherwise selecting, a buddy causes a menu to appear, which menu contains several options related to the buddy. For example, the menu may include the option of updating calendar information of the buddy (in a non-limiting embodiment, the menu does not include this option since the calendar information of buddies is updated in an automated or real-time fashion as described herein), sending the buddy a message, or opening up a buddy preferences window in which certain rules on interacting with the buddy may be set.

Buddies can be any entity with which an end user may want to share calendar information. In a non-limiting embodiment, buddies are contacts such as contacts stored on a third party software like Microsoft® Office Outlook®. Buddies in the buddy window 700 may include all contacts stored on a third party organizational software. In a non-limiting embodiment, the end user program 105 automatically synchronizes contact information on a third party software with the end user program 105 buddy list 705. Synchronization with third party software can be done in any suitable manner. In a non-limiting example, the end user program 105 directly accesses the files used by the third party software. In another non-limiting embodiment the personal information manager 100 establishes communication with a third party software, for example through e-mail messages or through an inter-program interface to perform synchronization. In yet another non-limiting embodiment synchronization is done manually by a user, for example by following instructions provided by the personal information manager 100. Synchronization may take place at every given time interval, whenever a certain change or a certain number of changes are made to calendar information (including buddy lists) or on command, for example upon the clicking of a “synchronize” button.

Optionally, a portion of the buddy window 700 includes a text field 715 for searching through the buddy list 705. To find a buddy in the buddy list 705, an end user can type the buddy's name in the text field to look him up. Alternatively, an end user may type a new name in the buddy list 705 to add a new buddy to the list. End user program 105 may accept the new buddy's e-mail address and other personal information relating to the new buddy and add him to the buddy list 705. In a non-limiting embodiment the end user program 105 then synchronizes with a third party software to enter the new buddy into the third party software's list of contacts. One skilled in the art will appreciate that there exist many ways of permitting a user to search through a list or to add an element to a list, all of which are within the intended scope of the invention.

In a non-limiting embodiment, the buddy window 700 includes in the buddy list 705 information about the buddies in the list such as a label, information on the category the buddy falls into and status information such as whether the buddy is online or not. In another non-limiting embodiment, the buddy list 705 can be organized into groups 720 by the end user. A user can create group, for example, by clicking on a “create group” button and giving the group a name. It is not necessary to organize buddies into a single group is, and in an exemplary embodiment each buddy can belong to multiple groups. Advantageously, groups 720 allow the end user to communicate with all the members of the group as if they were a single entity.

Message Window

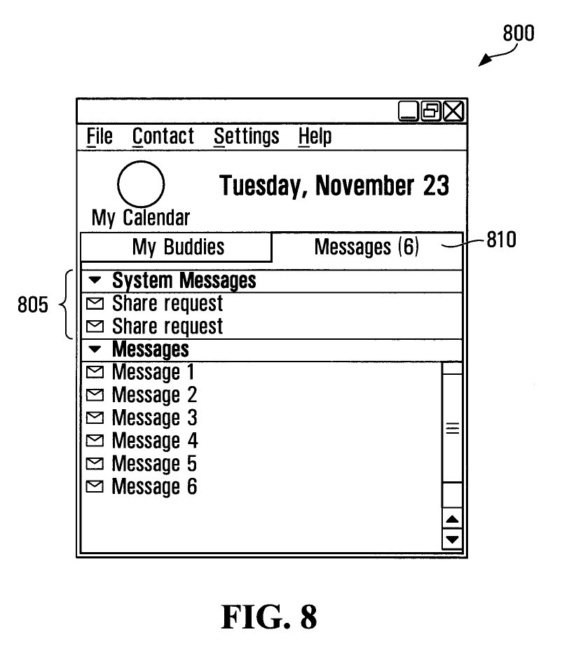

In a non-limiting embodiment illustrated in FIG. 8, an end user may also use the buddy window 700 to message buddies. In this embodiment a menu option allows the end user to create a message destined to his buddy, which message will be sent to his buddy via a dedicated personal information manager 100 interface or via e-mail. In a non-limiting embodiment, a history of past messages may be preserved by the end user program 105.

In a non-limiting embodiment, messaging a buddy may be initiated right in the buddy window 700. In this embodiment, clicking on the buddy or selecting a “send message” option from a menu with the buddy selected opens a write message window in which an end user may write a message destined for the buddy.

There may be a separate message window 800 showing all messages sent or received or alternatively, message notifications may be an integral part of the buddy window 700. In the latter, an icon may indicate when a message has been received form a given buddy, which icon may open the message when clicked. In the former the window message may resemble an e-mail inbox, containing therein all messages received or sent. The messages themselves may be opened within the message window 800 or in another window. In a non-limiting example, the message window 800 contains personal information management information 805 such as requests to share calendar information. Advantageously personal information manager information may thus be visible right in the message inbox such as to be able to see all the information on a meeting for which a non-user of personal information manager 100 is invited all in the same place. Optionally, the user has the ability to set in his user preferences whether he wants to show personal information manager information in his message window 800.

In a non-limiting example, the message window 800 appears as a tab 810 in the buddy window 700, which tab includes a number of unread messages or another form of notification that there are unread messages.

Calendar Window

The calendar window 900 is a window that presents calendar information 920, such as a calendar view of the end user's activities for a given period of time. Calendar data representing any calendar-related information such as a schedule of events for the user over any period of time is accessible by the user using end user program 105. In a non-limiting embodiment, calendar window 900 may include a small view 905 of a long period of time, such as two months and a more detailed view 910 of a selected amount of time, such as a week or a day. In a non-limiting embodiment, the end user is able to select an amount of time to display in the more detailed view 910, the amount of detail displayed being inversely relative to the amount of time to display. Selecting the amount of time may be done using appropriate graphical user interface tools such as by clicking on a button representing a pre-set range (such as 1 day, or 7 days, or 14 days), by selecting the range from a menu or by entering the range directly into a field provided therefor. In a non-limiting embodiment, the user can also select the time period to display in the small view 905 and in the more detailed view 910 in a similar manner and can also scroll through time using appropriate graphical user interface tools.

In a non-limiting embodiment, the small view 905 also contains calendar information but less detailed than the move detailed view 910. In one embodiment, small view 905 displays dates in bold where there is an activity on those days.

In a non-limited embodiment, the more detailed view 905 includes all the activities of the end-user and details pertaining to the activities. For example, meetings may be displayed thereon with details such as the name of the meeting. Other details activities may have include the invitees, a level of priority and whether or not a reminder is set for the activity. The exact level of detail presented in the more detailed view 905 may depend on the available space as a function of the range of time being displayed, the length of the activity itself and the size of the window. In a non-limiting embodiment, the end-user can use a graphical user interface tool such as double clicking on the activity representation in the more detailed view 905 to open a detailed window on the activity. The more detailed window on the activity may include all the information available on the activity and may also include additional options, accessible through graphical user interface tools such as buttons, text fields and menus. The additional options may include the option to invite more attendees, to cancel the activity, to withdraw from the activity, to set a priority level or to set/alter a reminder for the activity.

In a non-limiting embodiment, when a reminder is set for an activity, the end user program activates a graphical user interface tool to remind the user of an activity at a preset time prior to the meeting. The activated tools can include a sound to play over the computer's speaker and a visual cue. Optionally, the preset time at which the reminder is set may be selected by the end user and may be set relatively to the meeting time itself. In a non-limiting embodiment, the end user program 105 can synchronize with third party software to alter the third party software's reminders in response to its own or to alter its own reminders to reflect the third party software's.

In a non-limiting embodiment, the calendar window 900 may also present a view of buddy calendar information 915 of a selected one or more of the end user's buddies. This buddy calendar information 915 is obtained from a category 1 buddy through the peer-to-peer network 110. This calendar information may be less detailed than an end user's own calendar information and in a non-limiting example, a buddy's calendar information 915 may be limited to availability information, without any details on specific activities in the buddy's calendar. In this non-limited embodiment, an end user may select a number of buddies from the buddy list 705 whose calendar information 915 will be displayed in the calendar window 900. This calendar information 915 may be displayed in a color-coded fashion such as to help the end user discern which information relates to which buddy.

In a non-limiting embodiment, double clicking, or otherwise selecting, a buddy in the buddy list causes the calendar window 900 to display the buddy's calendar information 915. Optionally, if the calendar window 900 is not visible, so doing may cause calendar window 900 to become visible.

Similarly a buddy that corresponds to a trusted node that has authorization to receive information may request calendar information from the user, fore example upon logging on to the personal information manager. If changes are made by the user to his calendar information, information regarding the changes may be sent through the peer-to-peer network 110 to buddies that are authorized to receive such information.

An end user may use the personal information manager 100 to set up meeting with his buddies. Having selected a number of buddies with which to set up a meeting, the end user can then find in the calendar window 900 a timeslot for an activity (e.g. meeting) that suits every buddy selected. The end user can then invite all the concerned buddies either by manually sending an invitation for the chosen timeslot or by selecting the timeslot right on the calendar and, for example, clicking a “book meeting” button. Each selected buddy will then be sent an invitation for a meeting. In a non-limiting example, upon acceptance of the meeting by the buddies, the meeting will automatically be added to their calendar and their calendar information updated for each other user they are sharing information with. In another non-limiting example, upon acceptance of a meeting by a buddy, a confirmation may be sent to the end user. In yet another non-limiting example, the decline of the invitation by a single buddy may trigger the cancellation of the invitation/meeting for all invited buddies. In yet another non-limiting embodiment, the personal information manager 100 may cause the timeslot of the meeting invitation to be marked as tentatively busy in the invited buddies' calendar information until the meeting has been either accepted or cancelled. In a non-limiting example the timeslot remains tentatively busy until all invited buddies have accepted the invitation.

It is to be understood that while the end user setting up the meeting may be an invitee, this is not necessarily the case. Advantageously, it may be possible to send invitations to take part in an activity, such as a meeting, which he does not plan to attend. Advantageously, in this embodiment the end user program 105 may allow an administrative assistant to set up a meeting for one or multiple professionals.

In a non-limiting example, the calendar window 900 may be a sliding window that temporarily extends out of another window, such as the buddy window 700.

In a non-limiting embodiment, the calendar information of buddies that is available in the end user program 105 also becomes available in third party software.

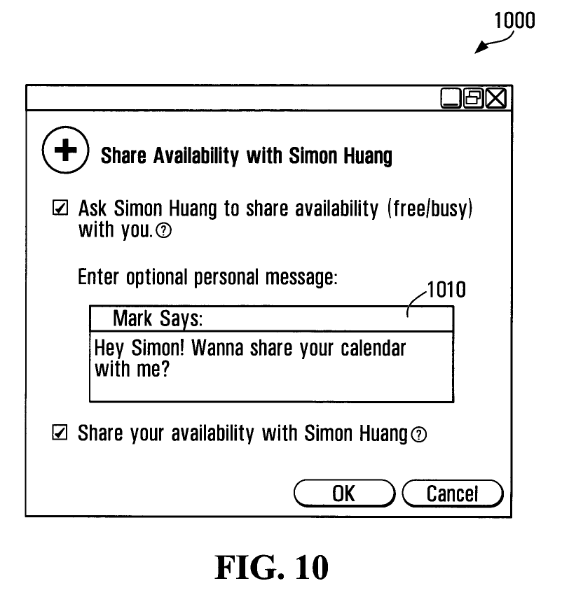

FIG. 10 illustrates non-limiting example of a share request window 1000. In order to share calendar information with a buddy in category 2, the end user can send the buddy an invitation to share calendar information. If the buddy accepts, his calendar information will be viewable in end user program 105. The invitation may include a personal message 1010 and may include an authorization for the buddy to view the end user's calendar information.

It should be noted that although the relationship between buddies using the personal information manager 100 is described as being either sharing or non-sharing, any number of different categories representing different sharing levels or schemes may be used. For example, it could be possible for a user to chose how much of his calendar information to share with another user, or to select a subset of his calendar information (such as a time period on a calendar or a level of detail of activities in a calendar or even information regarding communications with other buddies) to be shared.

Suggest Window

The suggest window 1100 offers an alternate way to set up a meeting with a buddy. In the suggest window 1100, an end user selects an acceptable range of time for a meeting to take place, such as an acceptable day range and an acceptable time range within the day, as well as the length of a meeting. This can be done using any suitable graphical user interface tool, including selecting from a drop-down menu and manually entering information in a text field. Once done, personal information manager 100 will attempt to find the best suitable time for a meeting for a selected group of buddies.

In a non-limiting embodiment, when the personal information manager 100 selects a suitable meeting time to suggest, the suggested meeting time may be displayed on the calendar window 900 on the end user program 105.

In another non-limiting example, the personal information manager 100 may require the end user to accept the suggested time before sending out invitations to other buddies. In another non-limiting embodiment, the suggested meeting time may be marked as busy in the invited buddies' calendar information upon suggestion by the personal information manager 100 or upon the sending out of an invitation to the invited buddies.

In addition to the above-described windows, other windows may be included such as a navigational bar presenting the end user with various options. Other windows may be opened as appropriate such as a window to manager one's profile or other end user program 105 options.

Although the functionality of the personal information manager 100 has been described with reference to graphical user interface windows, it should be appreciated that any other suitable means of providing the described functionality may be used, the specific of graphical or other means of presenting the functionality to the user being not intended to limit the scope of the invention. Furthermore, it should be specifically noted that the windows themselves may take the form of any means of displaying information to a user and do not necessarily correspond to conventional Microsoft Windows® window panes. The windows need not be static or persistently displayed. They may be combined together or split up into several sub-windows. The information provided by the windows may be presented in any suitable form to the end user and additional information may be provided in the windows.

Time Space

Advantageously, personal information manager 100 allows an end user to organize activities (e.g. meetings) effectively with buddies that are users of the personal information manager 100 as well as buddies that don't use personal information manager 100. In order to organize a meeting time with non-user buddies, an end user must first create a time space 1200. A time space 1200 is a representation of a time range in which a meeting is sought. To create a time space 1200, a user must instruct end user program 105 that he wants to create a time space 1200, for example by clicking on a button to that effect or by attempting to schedule a meeting with category 2 or 3 buddies. Once this done, the end user program 105 presents the end user with a time space 1200 creation window.

In the time space 1200 creation window, the end user must indicate invitees and information related to the meeting, such as the purpose/title of the meeting and the meeting duration. In a non-limiting embodiment, the creator of the time space 1200 is himself an invitee. This, is not, however, always the case as in some instances a user may want to organize activities for another user. The end user also indicates a range of time in which the meeting is to take place such as a range of days and a range of times during those days. In a non-limiting embodiment, the range of time indicated by the user is a time range described above and may include calendar information or availability information regarding the end user and/or any other users (e.g. the end user's buddies that are sharing their calendars with him and that are invited). The range of time can be indicated using any suitable means. Mechanisms for selecting a time range have already been described above, and in a non-limiting embodiment, graphical user interface tools such as those previously described are used to this end. The range of time selected represents a subset of the end user's calendar information that he chooses to make available to the meeting invitees. Once this done, a time space 1200 will be created containing the availability of the end user. Optionally, if some of the invitees are category 1 buddies of the end user's, their availability information may also be on the time space 1200.

The time space 1200 is then communicated to all the invitees in any suitable manner. In a non-limiting example the time space 1200 is contained on a server in a manner accessible by a web browser and made available to each meeting invitee in an e-mail communication sent to the invitees. In this non-limiting example, non-user invitees may access the time space 1200 in their web browser and select a specific meeting time or a range of times in which they are available for the meeting. Any suitable means and graphical user interface tools can be used to select a range of time in which the invitees are available and in a non-limiting example, invitees can select directly on a displayed calendar the range of time they are free in a graphical fashion, such as by clicking and dragging with a mouse, a rectangle around where they are free. Optionally, access to the time space is strictly restricted to the meeting invitees.

Time space may be hosted on a centralized server 330 described above. In a non-limiting embodiment, the centralized server 330 is a dual centralized server as described above. In this embodiment, centralized server may store time space 1200 data for access by both peer-to-peer network parties and client-server parties and may represent time space 1200 to either one or both as a web browser-viewable file including an input interface through which to accept input from the various invitees. Invitees are free to indicate when, in the range of time provided, they are available for the meeting. Any number of additional restrictions can be imposed, such as only allowing invitees to indicate free time where everyone else is free or only permitting chunks of time of at least the meeting length to be shown as free. Restrictions can be imposed in any suitable manner including in responding to restricted actions by not complying with them and playing an audible cue indicating action failed. As invitees modify the time space 1200 it is updated such that all invitees see the availability of other invitees. In a non-limiting example, the time space 1200 is stored on a centralized server 330 and is updated there such that as others access the file they see the most updated version. In another non-limiting example, the time space 1200 is stored locally on individual invitees' computers and is updated via update messages sent through the peer-to-peer network 110 or any other network. Update messages may be sent from centralized server 330 or from the invitee responsible for the change in the time space 1200. A non-limiting embodiment may also combine the two possibilities, the time space 1200 being stored on a centralized server 330 for access via a client-server interface and being also stored on individual user's computers for users accessing the centralized server 330 via a peer-to-peer protocol. In this embodiment, if an invitee (including the creator of the time space 1200) modifications to the time space 1200 are sent in update messages to all locations where the time space 1200 is stored via the peer-to-peer network. It is to be understood that the time space 1200 can also be stored on the local computers of invitees using the client-server protocol to communicate with a centralized server 330, in which case update messages may be sent to these invitees as well, but using the client-server protocol.

In a non-limiting embodiment, invitees may update their availability in response to viewing the time space 1200. For example, invitees may update their availability on their personal calendar to mark a time period corresponding to a potential invitation or an invitation as tentatively busy or busy. Alternatively, invitees may chose to change their availability on the time space 1200 in response to a conflict with another invitee's schedule. In this embodiment, if an invitee can see that there is no availability in common between himself and another invitee, he can chose to change his availability to ensure his available time overlaps with the other invitee or cause the sending of a message to the other invitee informing him of the time conflict. In a non-limiting embodiment, whenever a time conflict exists in which two or more invitees have indicated their available time and there is no available time in common, a message can be sent to the invitees to inform them of the time conflict. For example, a user indicating his availability may immediately be warned that his availability does not overlap with another invitee's and be offered the option of changing his availability, causing a message to be sent to the other invitee to inform him of the conflict or take no particular action.

When all invitees have responded by showing their available times, the personal information manager 100 may then automatically select a suitable time for everyone and send a formal invitation, optionally marking the time as tentatively busy on invitees' calendars. Alternatively, the personal information manager 100 may simply inform the end user, who called the meeting, that all have responded and may optionally also suggest a suitable time. In a non-limiting example, all invitees may have the right to send an invitation. This embodiment may be combined with any number of additional restrictions such as that the invitation can only be for a timeslot in which all invitees (including the creator of the time space 1200) are available or that only the last invitee to provide his availability may send the invitation. Advantageously, these two restrictions, when both applied, ensure that the invitation always corresponds to a time that suits all invitees.

Either way, once a meeting time is decided, invitations are sent to all invitees. Those invitees that are users of the personal information manager 100 may then have the meeting directly placed onto their calendar optionally receiving a request for permission to add the meeting or simply a notification that the meeting has been added. Non-users of the personal information manager 100 will receive a notification that the meeting time has been agreed upon and the meeting time details. In addition, they can see the meeting time in the time space 1200.

Integration with Third Party Service

In a non-limiting embodiment, the personal information manager 100 may be integrated with a third-party service to combine the functionality of the personal information manager 100 with that of the third party service. A third party service may be any tool or service, external to personal information manager 100, that complements personal information manager 100. In a non-limiting example, a third party service may be a teleconferencing service that forms an audiovisual connection between parties of a meeting.

The decision to employ a third party service may be taken at any time in the planning of an activity. For example, a user sending out an invitation to other users of the personal information manager 100 may include in the invitation a request to use a third party service. Optionally, it may be possible for invitees to refuse to use a proposed third party service or to amend an invitation by suggesting the use of a third party service, which amended invitation is sent to all invitees. Alternatively, a creator of a time space may, upon creation of a time space, incorporate in the time space a suggestion to use a third party service. Again optionally, invitees may refuse to use a third party service or suggest in the time space the use of a third party services. Also optionally, invitees in a time space may need to accept the use of a third party service or to validate their capability to use the third party services.

Information regarding third party services can be directions for users on how to access the services (e.g. telephone number, web address, username, password, etc . . . ) or computer instructions to cause a computer to access the service, and may be sent to invitees. In a non-limiting embodiment, arrangements can be made with the provider of the third party services at the time of the suggestion to use third party services to access them. In such a case, information regarding third party services may be sent with the invitation. In an alternate embodiment, arrangements can be made only after the use of the third party services has been confirmed, for example by the acceptance of the invitation by all invitees. In such a case, information regarding third party services may be sent only upon confirmation.

Arrangements to use third party services may be made from an invitee's computer or by a centralized server 330. In a non-limiting embodiment, a centralized server 330 is in communication with a third party service provider server and is capable of requesting third party services from the third party service provider. In this embodiment, parties wanting to employ third party services must communicate with a central server 330 to inform central server 330 of a desire to employ third party services. Optionally, details on the services and parameters required, such as the time and date of a meeting are sent as well. The centralized server 330 then communicates with the third party service provider and requests use of the services. Optionally information regarding third party services, or relating to one or more invitees (such as e-mail address, telephone number, an internet location indicator like an IP address, an account number or a user ID) may be sent to the third party service provider by the centralized server. Alternatively users may be directly connected to the third party provider and are capable of requesting third party services directly from the third party provider. The third party service provider may respond with information indicative of the availability of a conference resource such as an acceptance/decline to the request and may also communicate details on the third party service, such as instructions on how to access the service to the centralized server 330. The centralized server 330 may then communicates to invitees information regarding third party services. In an alternate embodiment, the third party service may communicate directly with one or many invitees or planners of the activity. It may be necessary for all invitees to receive information regarding third party services or for just one. For example, if the third party service is a web conference service, they may all need log-in information. On the other hand if the third party service is a telephone conference service, it may only be necessary for one party to

Besides connectivity services like teleconference and data-sharing services, third party services may be any other services that facilitate a meeting. For example, in a non-limiting embodiment, third party services are hotel, flight, or restaurant booking services. In such a case, it may be necessary for details of the service to be sent to participants in advance of a planned activity.

1. A graphical user interface implemented on a computer for sharing calendar information with a third party residing at a remote site, said graphical user interface comprising:
a. a selection tool operable by a user on the computer for selecting a time range from a calendar program executed by the computer, the calendar program maintaining a schedule of events for the user over a certain time period, wherein the time range is a subset of the certain time period, the time range being characterized by:
i. one or more free time slots within the time range, whereby the user is available for taking part in an activity;
ii. one or more busy time slots within the time range, whereby the user is unavailable to take part in an activity;
b. said selection tool causing the time range to be exposed to the third party residing at a remote site such that the third party can determine the free and busy timeslots.

2. A graphical user interface as defined in claim 1, wherein the time range begins at a determined start date and ends at a determined end date.

3. A graphical user interface as defined in claim 1, wherein the time range:
a. includes a succession of time slots spread over a plurality of consecutive days;
b. excludes the time outside the succession of time slots.

4. (canceled)

5. A graphical user interface as defined in claim 1, wherein said selection tool is a graphical tool.

6. A graphical user interface as defined in claim 5, wherein said selection tool is operable by a pointing device to select the time range over a visual representation of the schedule of events or a portion thereof.

7. A graphical user interface as defined in claim 6, wherein said selection tool is operable by dragging the pointing device:
a. from a start date within the visual representation of the schedule of events or a portion thereof;
b. to an end date within the visual representation of the schedule of events or a portion thereof.

8. A computer readable storage medium storing instructions for execution by a first computer to implement a calendar sharing program, the calendar sharing program including:
a. a selection module responsive to inputs by a user on the first computer for selecting a time range from calendar data, the calendar data containing a schedule of events for the user over a certain time period, wherein the time range is a subset of the calendar data, the time range being characterized by:
i. one or more free time slots within the time range, whereby the user is available for taking part in an activity;
ii. one or more busy time slots within the time range, whereby the user is unavailable to take part in an activity;
b. a communications module to generate a transmission conveying the time range for reception by a remote computer allowing a user at the remote computer to visualize the time range.

9. A computer readable storage medium as defined in claim 8, wherein said communications module is responsive to a modification of the calendar data, occurring subsequent the occurrence of the transmission, which changes a free time slot within the time range into a busy time slot, to generate an update transmission conveying the modification in order to update the time range at the remote computer.

10. A computer readable storage medium as defined in claim 8, wherein said communications module is responsive to a modification of the calendar data, occurring subsequent the occurrence of the transmission, which changes a busy time slot within the time range into a free time slot, to generate an update transmission conveying the modification in order to update the time range at the remote computer.

11. A computer readable storage medium as defined in claim 8, wherein the communications module is operable for receiving from the remote computer a message indicative of an intention of the user at the remote computer to take part in an activity.

12. A computer readable storage medium as defined in claim 11, wherein the communications module is operative to alter the calendar data in response to the message indicative of an intention of the user at the remote computer to take part in an activity.

13. A computer readable storage medium storing instructions for execution by a first computer to implement a calendar sharing program, the calendar sharing program including:
a. a selection module responsive to inputs by a user on the first computer for selecting a time range from calendar data, the calendar data containing a schedule of events for the user over a certain time period, wherein the time range is a subset of the calendar data, the time range being characterized by:
i. one or more free time slots within the time range, whereby the user is available for taking part in an activity;
ii. one or more busy time slots within the time range, whereby the user is unavailable to take part in an activity;
b. a communications module to generate a transmission conveying the time range for reception by a web server allowing a user at a remote computer to visualize the time range from the web server by using a web browser.

14. A computer readable storage medium as defined in claim 13, wherein the time range begins at a determined start date and ends at a determined end date.

15. A computer readable storage medium as defined in claim 13, wherein the time range:
a. includes a succession of time slots spread over a plurality of consecutive days;
b. excludes the time outside the succession of time slots.

16.-20. (canceled)

21. A computer readable storage medium as defined in claim 13, wherein the communications module generates a data message for reception by the remote computer including an invitation to the user at the remote computer to access the time range on the web server via the web browser.

22. A computer readable storage medium as defined in claim 21, wherein the data message conveys a link to the location of the time range on the web server.

23. (canceled)

24. A computer readable storage medium as defined in claim 13, wherein said calendar sharing program further including an invitee selection tool, responsive to inputs from the user to designate identities of users at remote computers to be invited to access the time range.

25. A computer readable storage medium as defined in claim 24, wherein said communications module is responsive to said invitee selection tool to generate a data message destined to each one of the users at remote computer designated by the user to invite each one of the designated users to access the time range at the web server.

26. A computer readable storage medium as defined in claim 13, wherein the communications module is operable for receiving from the web server a message indicative of an intention of the user at the remote computer to take part in an activity.

27. A computer readable storage medium as defined in claim 26, wherein the communications module is operative to alter the calendar data in response to the message indicative of an intention of the user at the remote computer to take part in an activity.

28.-57. (canceled)
